(19) United States
(12) Patent Application Publication
(10) Pub. No.: US 2012/0226517 A1
(43) Pub. Date: Sep. 6, 2012

(54) System and Methods for Communicating Mediated Knowledge

(75) Inventor: Paikray Prasad Sitaram, New Delhi (IN)

(73) Assignee: INTERNATIONAL TRACEABILITY SYSTEMS LIMITED, New Delhi (IN)

(21) Appl. No.: 13/505,528

(22) PCT Filed: Oct. 4, 2010
(86) PCT No.: PCT/IB10/54477

§ 371 Date: May 2, 2012

(30) Foreign Application Priority Data
Nov. 19, 2009 (IN) 2380/DEL/2009

(51) Int. Cl. G06Q 10/04; G06Q 10/06

(52) U.S. Cl. 705/7.25; 705/7.36

(57) ABSTRACT

The present invention discloses a method of identification and problem solving in agriculture for holistic enhancement of agriculture productivity, sustainability and profitability on location specific in a real time basis. The method comprises the steps of: preparing a block profile by collecting field data, facilitating a District Level Resource Person (DLRP) in planning of location specific fanning system based education and communication activities including customized farmers training and on-farm demonstration, transferring real time data on crop growth and coverage to a central computer through a communication means, developing at least an advise by analyzing the data by the central computer, and delivering the advise to farmers. The present invention also discloses a Rational Unified Process of extension program management involving inter-sectoral, inter-organizational and interpersonal communications coupled with consensus-building, negotiation, networking and multidisciplinary capacity building in a multi-cultural settings at different levels.

### FIELD OF THE INVENTION

The present invention relates generally to information communication, and more particularly to system and methods, for communicating mediated knowledge for holistic enhancement of agriculture productivity, sustainability and profitability on location specific basis in a convenient, cost effective, and environmentally safe manner

### BACKGROUND OF THE INVENTION

Achievement of targeted growth rate in agriculture, for example 4 percent growth rate in India, is a great challenge as the agriculture in India is significantly influenced by a large number of biotic and a biotic condition in different agro-ecological and agro-climatic zones in the country. Effective management of existing resources is the key for increasing productivity and profitability of agriculture, which requires knowledge based extension service facilitating application of technology, instead of traditional extension service operating on technology transfer mode. The technology transfer mode of extension has been successful for the well endowed production system with largely uniform farming systems practiced by resource rich farmers. On the other end, there are wide diversity in farming systems often called as Complex, Diverse and Risk prone Agriculture practiced by the large majority of resource poor farmers, which requires more knowledge for application of technology on location specific basis in different farming systems and even within a farming system depending on the variation in resource endowments.

Earlier the capital was considered as the scarce factor in production and transfer of capital was considered as the key instrument of growth. Knowledge is now considered to be more important a factor in development, knowledge accumulation and application are the key to drive development processes. There has been revolution in information and communication technology facilitating rapid growth in systematic assimilation and dissemination of relevant and timely information which has dramatically improved the ability to access the universe of knowledge and communicate. Today the farmers not only require knowledge of improved technology, but also large volume of information related to weather, market, availability of inputs, government schemes, sources of credit, and quality requirement for the agricultural produce.

Various patent documents describe methods of analysis of agricultural extension services such as JP Patent No. 2005135235 which discloses a crop information management system to ascertain the amount of pesticide residue and its traceability information which can be browsed and retrieved anytime anywhere via the Internet. United States Patent publication No. 2001037182 discloses a process for analyzing the traits of various agricultural products including plant seed, the resulting crop, food items made from the crop, and the like, at various locations. International Patent Publication WO/2008/010234 discloses a tool for IT-based personalized Agro-Advisory system to improve farm productivity by delivering agro-expert advice to each farm from pre-sowing stage to post-harvesting stage. Chinese Patent No. CN 1409251 (A) discloses management information system for agriculture and aquaculture which includes collection of information from the producers and facilitating its sharing by the producers. The Chinese Patent No. CN 1302033 (A) discloses the space-time positioned collecting, processing and analyzing of field culture information.

In India the existing extension service is operated under the central scheme on “Support to State Extension Programmes for Extension Reforms”. The scheme is implemented through Agricultural Technology Management Agency (ATMA) created as a registered society at the district level with the main responsibility for implementing all technology dissemination activities at the district level. ATMA is supported by a Governing Body (GB) and a Management Committee (MC). Under each ATMA, there is Farm Information Advisory Centers (FIACs) at the block level and operated by Block Technology Team (BTT) of technical advisors and a Farmer Advisory Committee (FAC). Farmer Interest Groups (FIGs) based on commodity are promoted at block/village level. The set up include establishment of State Agricultural Management and Extension Training Institute (SAMETI) at the state level to provide HRD support in extension delivery mechanism. There is a provision for preparation of Strategic Research and Extension Plan (SREP) by each ATMA for implementation of extension programmes in each district.

Considering different functional areas of ATMA and associated institutional arrangements, the overall level of satisfaction of the beneficiaries is 25%. The linkage of research, extension, farmers and marketing agencies were found to be very weak. Though ATMA based extension service facilitates in acquiring new knowledge about improve crop and livestock management practices. Further, the follow-up programmes also seem not adequate for developing positive attitude towards such improved technologies.

The SREP which is the basic document for implementation of extension program in a district, in many instances, did not match with the real situation in the operating areas. Further, there seems to be lack of adequate follow up of the training programs and demonstrations with input and information support and further encouraging appropriate public-private partnership.

Drawbacks of Existing ATMA Based Agricultural Extension Service:

The Strategic Research and Extension Plan (SREP) takes into account only static information before initiating the implementation of extension programs. While broad agro-eco systems are considered, the detail analysis in the form of block and village profile is not done. Further, training programs formulated are of general in nature, by and large confining to increasing productivity under well endowed resource situation. There is lack of variability with the dynamic changes in the farming situations like weather and differential resource base. Indigenous technical knowledge (ITK) base of the farmers is not considered.

There is no application of information communication technology (ICT) in ATMA based extension services. The advisory services are prefixed and therefore do not meet the requirement based on changing needs due to change in real time situation. Further more, the monitoring of the extension programme is done based on prefixed procedure of periodic reporting in the context of the annual target of different activities under the overall target for five years. Such procedure lacks flexibility in adjusting the programme based on the changes in requirement.

Also, as the program and the activities are prefixed there is no scope for such activity in the existing extension service. Besides, the system lacks adequate capacity for providing such precision advisory services. Further, as the constraints of marketing are identified as a part of SREP, the existing extension service does not provide any scope for providing market information including market intelligence to equip the farmer with a likely supply-demand situation.

An extension program cannot be successful based on a straight-jacketed approach. Especially, any extension program is required to be implemented among the farmers with large variations in their ethnic background including cast, religion etc. The uniformity being the basis for the existing extension system does not provide such scope of flexibility due to variation in cultural settings.

Since the existing extension service is not ICT enabled, it depends on providing static information based on personal query only and also lacks capacity for facilitating any decision or policy prospective to the farmers, planners, input agencies, exporter and importers of agricultural products, industries and other agencies. Further, there is no follow upon the outcome of the advisors, the system therefore lack any feedback mechanism

In views of the disadvantages inherent in the existing extension service systems and methods, there exists a strong need for making the technology support services of ATMA more demand driven and location specific with multiple technological options.

### SUMMARY OF THE INVENTION

In view of the disadvantages inherent in the conventional systems and methods of extension service, the general purpose of the present invention is: to provide system and methods for a conceptual-mix ICT Mediated Knowledge Based Extension Service which includes Situational Analysis of Farming System, Location Specific Planning, Problem Solving Mode of Implementation, Results Based Monitoring, Inbuilt Risk-Alert System, Micro Level Market Information, Process Based Management, and finally Inbuilt Decision Support System. The present invention takes into account the real time information and socio-economic background of farming systems based on real-time resource mapping including: micro flora profiling and dynamic block and village socio-economic profiles; the concept of Location Specific Planning includes customized trainings based on dynamic block profile including real-time weather, water and soil resources, joint diagnosis on farmers' “felt” needs, and related Indigenous Technical Knowledge (ITK); ICT based System for implementation of agricultural extension programme by providing advisory services and needed inputs observing real time crop conditions; ICT based monitoring system of agricultural extension programme through real time cropped area and crop growth; Risk assessment and Quick Alert based on real-time data captured right at the location of risk; market information and intelligence on demand-supply situation of quantity and quality of farm commodities in the local markets, extension programme management based on unified process of inter-sectoral, inter-organizational and interpersonal communications coupled with consensus-building, negotiation, networking and multidisciplinary capacity building in a multi-cultural settings; and ICT based Decision Support Systems (DSS) facilitating efficient agriculture management and decision making by the farmers and all other stakeholders.

These together with other aspects of the present invention, along with the various features of novelty that characterize the invention, are pointed out with particularity in the claims annexed hereto and forming a part of this disclosure. For a better understanding of the present invention, its operating advantages, and the specific objects attained by its uses, reference should be made to the accompanying drawings and descriptive matter in which, there are illustrated exemplary embodiments of the present invention.

### OBJECTS OF THE INVENTION

The principal object of the present invention is to move away from the concept of technology transfer to the concept of technology application.

Another object of the present invention is to provide a method of providing knowledge instead of providing information.

According to an another object, the present invention relates to process of ICT enabled implementation based on real time crop condition, ICT based result monitoring mechanism through real time cropped area and crop growth and risk assessment and Quick Alert System (QAS) to transmit information on likely crop hazard for instant advise.

According to an object, the present invention relates to rational unified process of extension programme management in multicultural settings at different levels and ICT based Decision support System to facilitate decision making by the stakeholders based on the databases on situational analysis, evaluation and problem solving.

According to an object, the present invention provides online market intelligence for higher profitability.

According to an object, the outcome of the system and methods of the present invention may bring increase in productivity and profitability of crop sector in inclusive manner covering vast spectrum of farm holdings across the defined area.

### ADVANTAGES OF THE INVENTION

In one aspect, the present invention provides a process of planning location specific farming system based educational and communication activities to facilitate adoption of technology at different geographic regions.

In another aspect, the present invention provides a process of planning location specific farming system based educational and communication activities to facilitate adoption of technology at different geographic regions.

In another aspect, the present invention provides an ICT enabled system for implementation of agricultural extension programme by providing advisory services and needed inputs based on real time crop conditions.

In another aspect, the present invention provides a Risk assessment and Quick Alert System (QAS) based on real time data captured right at the location of risk, enabling timely information to the farmers as well as the decision making authority.

In another aspect of the present invention, an ICT enabled result based monitoring system is done through real time cropped area and crop growth.

In another aspect, the present invention relates to a process of ICT based market intelligence to facilitate decision making by the farmers based on demand-supply situation of quantity and quality of different agricultural produce.

In another aspect of the present invention, an ICT based Decision Support Systems (DSS) is capable of facilitating efficient agriculture management and decision making by the farmers and all other stakeholders. The present invention provides an ICT enabled system for implementation of agricultural extension programme by providing advisory services and needed inputs based on real time crop conditions.

In another aspect, the present invention provides Risk assessment and Quick Alert System (QAS) based on real time data captured right at the location of risk, enabling timely information to the farmers as well as the decision making authority.

In another aspect, the present invention gives an ICT enabled result based monitoring system is done through real time cropped area and crop growth.

In another aspect, the present invention is capable of taking into account both existing and real time information on socio-economic background of farming systems based on resource mapping including micro flora profiling based on initial block and village profiles.

In another aspect, the present invention provides customized trainings based on dynamic block profile and resource mapping, joint diagnosis on farmers' “felt” needs, and customization with Indigenous Technical Knowledge (ITK) and socio-economic background, real-time weather, soil micro flora, water and soil resources.

In another aspect, the present invention provides an ICT based System for implementation of agricultural extension programme by providing advisory services and needed inputs through selection, prioritization and utilization of real time crop conditions.

According to an aspect of the present invention, a monitoring is result based and not procedure based. The ICT based monitoring system of agricultural extension programme is done through real time cropped area and crop growth in the light of agronomic practices used based on real time crop conditions.

In another aspect, the present invention provides Risk assessment and Quick Alert based on real time data captured right at the location of risk, enabling timely information to the farmers as well as the decision making authority about the risk and crop hazard due to incidence of pest/disease, micronutrient deficiency and sudden change in weather parameters, likely effects on crops and immediate measures.

According to an aspect of the present invention, market information and intelligence to the extent of forecasting expected arrivals of farm commodities in Mandis as assessed from crop condition and yield estimation.

According to an aspect of the present invention, an extension programme management system involves inter-sectoral, inter-organizational and interpersonal communications coupled with consensus-building, negotiation, networking and multidisciplinary capacity building in a multi-cultural settings.

According to an aspect of the present invention, an ICT based Decision Support Systems (DSS) is capable of facilitating efficient agriculture management and decision making by the farmers and all other stakeholders.

In another aspect, the system and methods of communicating mediated knowledge is a perfect blend of both personal query based as well as ICT based for providing both static and dynamic information.

In another aspect of the present invention, as both implementation and monitoring are done based on real time crop situation, there is inbuilt feedback on the outcome of advice. Accordingly, the system and methods of communicating mediated knowledge of the present invention is a feedback based system.

### BRIEF DESCRIPTION OF THE DRAWINGS

The drawings and their brief description have been simplified to illustrate the elements that are relevant for a clear understanding of the present invention, while eliminating for the purpose of clarity, other elements of a conventional telecommunication network, e.g., the operating system details and modules of the intelligent platform of the network have not been described herein. The advantages and features of the present invention will become better understood with reference to the following more detailed description and claims taken in conjunction with the accompanying drawings, wherein:

FIG. 1 illustrates a flow chart of operation model, according to an exemplary embodiment of the present invention;

FIGS. 2 to 4 illustrate an online map of Basti district of Utter Pradesh, India, wherein eleven blocks of district with risk status, summary of customized farmer training organized and its block wise details, weather information and agro-met advisory are provided, according to an exemplary embodiment of the present invention;

FIG. 5 illustrates a cropped area, crop condition, expected yield, and availability of produce in the market on real time basis, according to an exemplary embodiment of the present invention;

FIG. 6 illustrates details of risk affecting crops and animals and area under crop/number of animals affected and estimated lost in Kudaraha block of Basti district, according to an exemplary embodiment of the present invention; and

FIG. 7 illustrates market price available quantity and quality in different markets and further details in different blocks of the district, according to an exemplary embodiment of the present invention.

Like reference numerals refer to like parts throughout several views of the drawings of the present invention.

### DETAILED DESCRIPTION OF THE INVENTION

For a thorough understanding of the present invention, refer to the following detailed description, including the appended claims, in connection with the above-described drawings. Although, the present invention is described in connection with exemplary embodiments, the invention is not intended to be limited to the specific forms set forth herein. On the contrary, it is intended to cover such alternatives, modifications, and equivalents as may be reasonably included within the scope of the invention as defined by the appended claims.

In the following description, for purposes of explanation, numerous specific details are set forth in order to provide a thorough understanding of the present invention. It will be apparent, however, to one skilled in the art that the present invention may be practiced without these specific details.

As used herein, the terms ‘a’, ‘an’, ‘at least’ do not denote a limitation of quantity, but rather denote the presence of at least one of the referenced item, and ‘a plurality’ denotes the presence of more than one referenced items.

The present invention provides a system and method for Communicating mediated knowledge/information to enables the farmers to access and locate needed information to improve their farm productivity, simulate the growing season, plan for weather contingencies, visualize precision data, decide on treatments, manage finances, buy inputs, monitor prices in local as well as other markets, and sell outputs. The farmers may be linked with various agencies like Business, Systems, Research institutions, Public administration, Credit institutions, Market agencies, other farmers and other unlimited partners. Information and Communication Technology (ICT) with its potential to hold a large volume of information through information technology and further communication through networking provides a great opportunity for access and further application on location specific basis.

According to an exemplary embodiment, the present invention relates to a method for ICT Mediated Knowledge Based Extension System which is a powerful process for developing understanding on various technologies and related information by engaging the farmers and other end users through multiple forms of representations on interconnection mode for working out solutions to a number of real life problem situations.

According to an exemplary embodiment of the present invention, the process is complementary to insufficient extension staff and transport facilities, language barrier, reduced resources for public extension services, in geographical terrain and in areas where physical visits may not be possible as frequently as required.

According to an exemplary embodiment, the mediated knowledge based extension system of the present invention facilitates in developing a Rural knowledge Society through Knowledge empowerment, social mobilization of the community, empowering rural people in decision making, increased food security through higher agriculture production, and higher economic security from the production with quality specification, increased on-farm and non-farm employment, and increased capital flow. Further, the present invention supports a different management model for extension service, creates a different supportive role of the Government, facilitate in institutionalizing a unique public-private-community partnership at the grass root level, provide opportunities for the farmers to adopt appropriate and affordable technologies, and overall facilitate community mobilization and improved functional understanding of the farmers.

According to an exemplary embodiment, the present invention provides decision support system (DSS) to help officials of line department, policy makers and planners to take advantage of database to prefix the targets and make availability of inputs and arrange for management of gluts and short supplies. Furthermore, the presence of online weather, soil maps, crop area and crop growth database can predict the yield in advance before the produce actually hits the market. The “Online” information on weather, soil and crop management ultimately saves the farmers from unexpected losses and resultant distress.

According to an exemplary embodiment, the present invention provides an innovative method of analysis of farming systems; a process of planning location specific farming system based educational and communication activities; an ICT based process of implementation of agricultural extension programme; an ICT based results monitoring mechanism; Risk Assessment and Quick Alert Communication System (QAS); an ICT based acquiring, analyzing and providing market information; a method of extension programme management; and an ICT based Decision Support Systems (DSS).

Operation of ICT Mediated Knowledge Based Extension Service: The operation of ICT Mediated Knowledge Based Extension Service is as follows:

1. Method of Analysis of Farming Systems:

According to an exemplary embodiment of the present invention a system of analysis of farming may takes into account the real time information both on bio-physical and socio-economic background of the farmers in the targeted villages. The system of analysis may be based on at least any one of a dynamic block and village profiles and resource mapping including micro flora profiling, or any combination thereof. The bio-physical parameters include not only information on crops and livestock but more specifically their interaction between and among different crops and livestock and also with various natural resources like weather, soils, water, pests and diseases, and other related factors determining the technical feasibility and economic viability of various production practices. In addition to the information on existing bio-physical parameters, real time information may be collected by establishing meteorological station at block level to facilitate precise advisory services on real time basis including risk assessment and quick alert on likely effect of sudden changes of weather parameters on crops and immediate remedial measures. The socio-economic endowment of the targeted villages having important bearing on adoption of improved technology includes existing process of social stratification like caste and religion structure, education status, village based cottage industries, overall economic status of the villagers specially holding size and purchasing power.

According to an exemplary embodiment of the present invention, weather conditions and soil types may be directly determine the cropping pattern in a particular village. The weather parameters include mainly rainfall, temperature and relative humidity. The soil parameters include texture (clay, clay loam, loam, sandy soil, river bed soil etc), nutrient status, organic matter, pH, water holding capacity and duration of water logging in case of water logging situations. The factors contribute to the choice of specific crop/variety, sowing time, cultural operations, harvesting time and over all crop duration. Unlike conventional focus of farming system, the available water resources both surface as well as under ground are ascertained including nature of water and depth of under ground water. The details of the crops grown in the area are analyzed including horticultural crops particularly fruits and vegetables and the choice for specific varieties, prevalence of pests and diseases, availability and utilization of organic waste and other composts, status of farm mechanization and extent of use of farm machineries, tools and implements, status of animal husbandry and extent of utilization of animal power. Market information being one of the key component in the present extension system, the particulars of market infrastructure are collected which include location of markets, distance from the village, frequency and mode of transportation and type of road which affect market the demand of crops and its by products.

2. Process of Formulating Farming System Based Location Specific Customized Farmers' Trainings and On-Farm Demonstrations:

According to an exemplary embodiment of the present invention, the customized training programmes and technology for on-farm demonstrations may be formulated based on the information collected on both bio-physical and socio-economic situations of the villages including the information on block profile and resource mapping besides the assessment of felt needs of the farmers based on analysis of the results of Participatory Rural Appraisal. The important considerations in the process of customization are soil and water resources, soil micro flora, and real time weather and related Indigenous Technical Knowledge (ITK) of the farmers besides their socio-economic background. Such customized training programmes and on-farm demonstrations cover specific interventions like implication of soil fertility status, selection of quality planting material including its duration to fit into the farming system, seed replacement, nursery management, optimum amount and time of use of input, method of input application, water scheduling, control measure for pests and diseases based on its seasonal incidence including natural control, application of manures and fertilizers, seasonal weeds control, management of natural resources and farm resources within cropping season, post harvest handling, packaging, storage, use of market intelligence and marketing. Similar customized training programmes may be formulated on animal husbandry, dairy and fisheries to cover the entire farm sector for its holistic development.

3. ICT Based System for Implementation of Agricultural Extension Program:

According to an exemplary embodiment, the present invention provides advisory services based on real time crop conditions. Such services include at least any one of weather forecasting, weather and crop advisory; SMS based services; solution to farmers' problems through call center; cropped area, crop conditions and yield assessment; market information on quality, price and quantity of arrivals, minimum support price and day to day market rates, availability of agricultural inputs and there prices; forecast on expected arrivals of farm commodities in Mandis as assessed from Crop condition and yield assessment, or any combination thereof.

4. ICT Based Monitoring System of Agricultural Extension Programme:

According to an exemplary embodiment of the present invention, the ICT based monitoring system of agricultural extension programme may be done through real time cropped area and crop growth providing much needed flexibility for appropriate advisory services and even redesigning the format and procedure based on the change in situations on real time basis.

5. Risk Assessment and Quick Alert Communication System:

According to an exemplary embodiment of the present invention, a Risk assessment and Quick Alert Communication System (QAS) is based on standard short message service to capture real-time data at the location of risk and to provide timely information to farmers as well as decision makers both at the project level and line departments about the risk or crop hazard from insect, diseases, micro nutrients deficiency, low and high temperature, frost, high pressure winds, floods, drought etc. and need for immediate remedial measures. The software may be independent of Internet access and may be operated even where internet connectivity is not available. Each Block Resource Person (BRP) under Agriculture Center (AC) of a district is provided with a QAS device. The device contains pre-loaded digital forms which are filled up by the BRPs and the data is immediately transferred to a central server. The BRPs may also review the old data and update the status accordingly. Similarly data on the crop from all the BRPs of all ACs, are digitally stored in a central server, where it is analyzed for assessment of risks and reports are generated through automated software. Based on the weekly reports of different districts/blocks/agriculture centres/villages, weekly e-alert is sent to the respective BRPs into their QAS devices to inform about fresh alert and also to remind to follow up the old cases. An online web link is given to the concerned authorities in charge to effectively monitor the progress of work of the program in different districts.

6. ICT Based Market Information System:

According to an exemplary embodiment of the present invention, the information include market rates of major agricultural commodities of the nearest markets, quantity and quality of produce received in the nearest market, and expected gluts and shortages of agricultural commodities, area sown and crop conditions and yield assessment. This information is upgraded on weekly basis and available on line to facilitate appropriate strategies.

7. Extension Programme Management System:

According to an exemplary embodiment of the present invention, the Extension programme management system of the present invention involves inter-sectoral, inter-organizational and interpersonal communications coupled with consensus-building, negotiation, networking and multidisciplinary capacity building in a multi-cultural settings. Uniformity in form and structure is the characteristic features of present extension system of the present invention. An extension program cannot be successful based on such a straight-jacketed approach. Especially, any extension program is required to be implemented among the farmers with large variations in their ethnic background including cast, religion etc. The uniformity being the basis for the conventional extension systemS does not provide such scope of flexibility due to variation in cultural settings.

8. ICT Based Decision Support Systems (DSS):

According to an exemplary embodiment of the present invention, the extension programme of the present invention provides a decision support system (DSS), through various databases; which help the officials of line department, policy makers and planners engaged in development of agriculture to take advantage to prefix the production targets and work out logistics for inputs as well produce management. Furthermore, the presence of online weather, soil map, crop area and crop growth database can predict the yield in advance before the produce actually hits the market. The “Online” information on weather, soil and crop management ultimately saves the farmers from unexpected losses and resultant distress.

Further aspects of the invention will become apparent from consideration of the drawings and the ensuing description of further embodiments of the invention. A person skilled in the art will realize that other embodiments of the invention are possible and that the details of the invention can be modified in a number of respects, all without departing from the inventive concept. Thus, the following drawings and description are to be regarded as illustrative and exemplary in nature and not restrictive.

### EXAMPLE 1

### Method of Analysis and Process of Formulating Farming System and Implementation

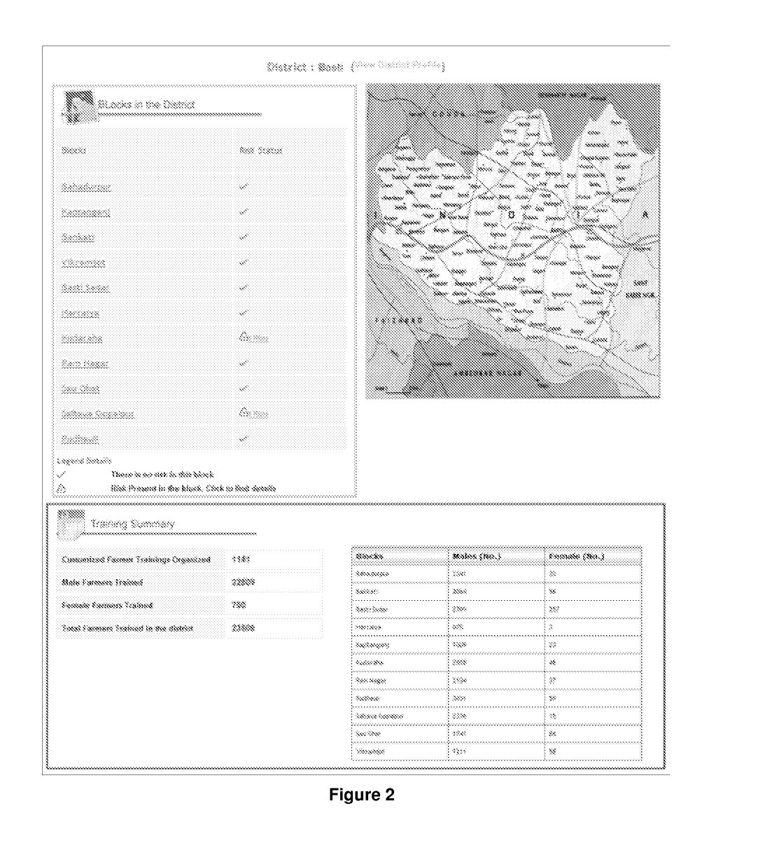

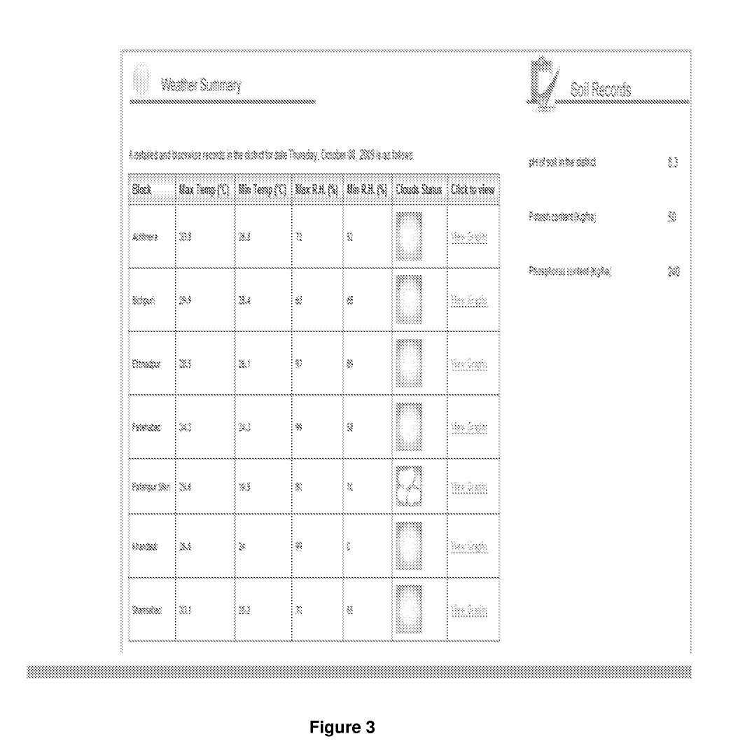

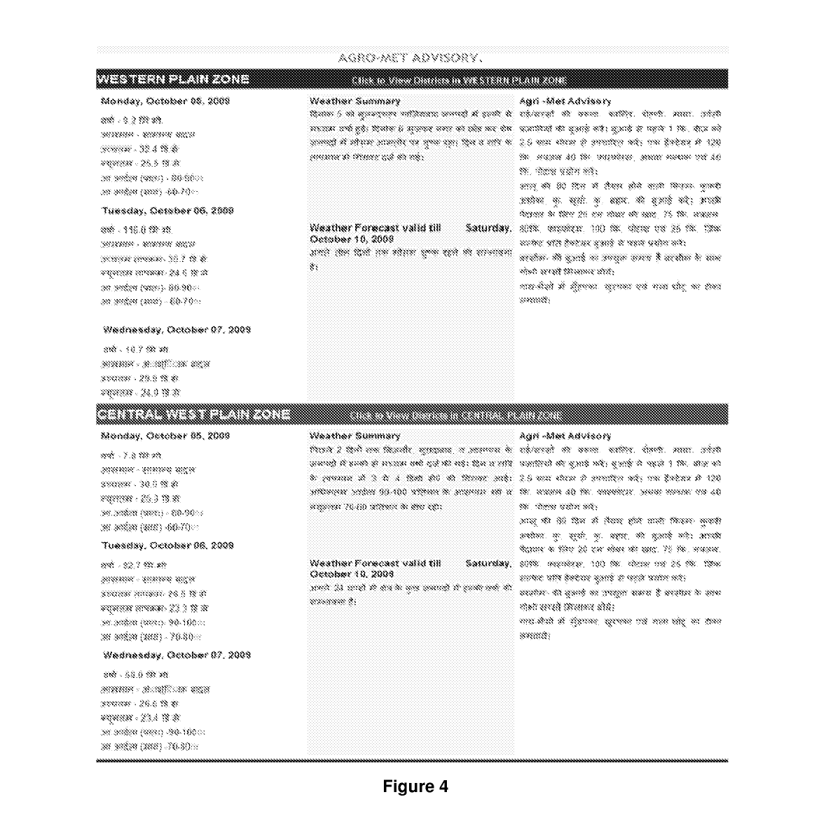

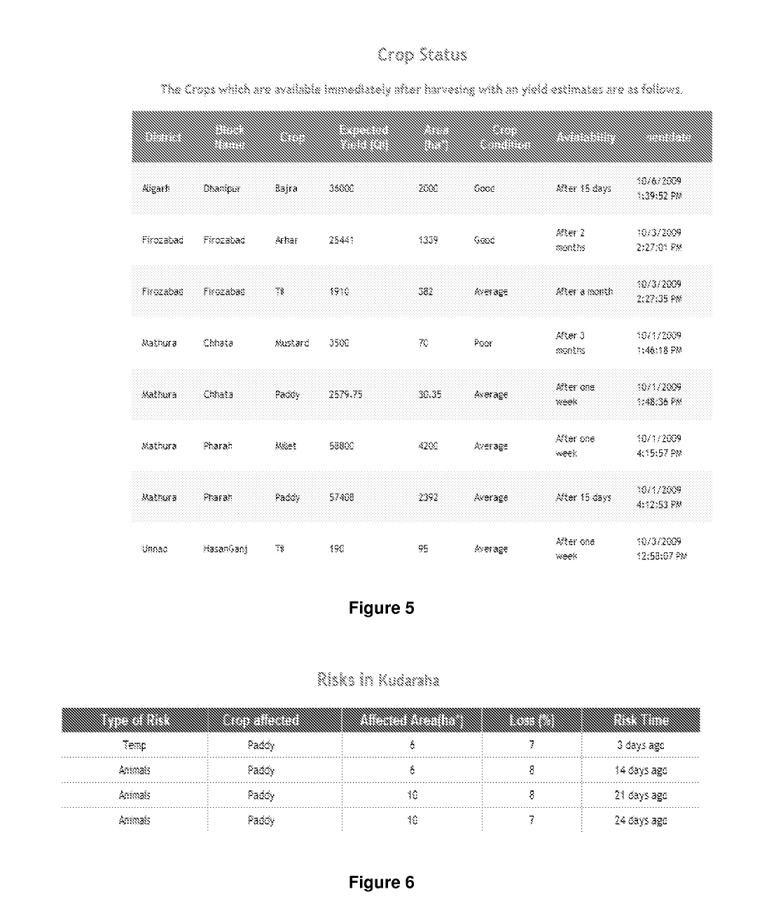

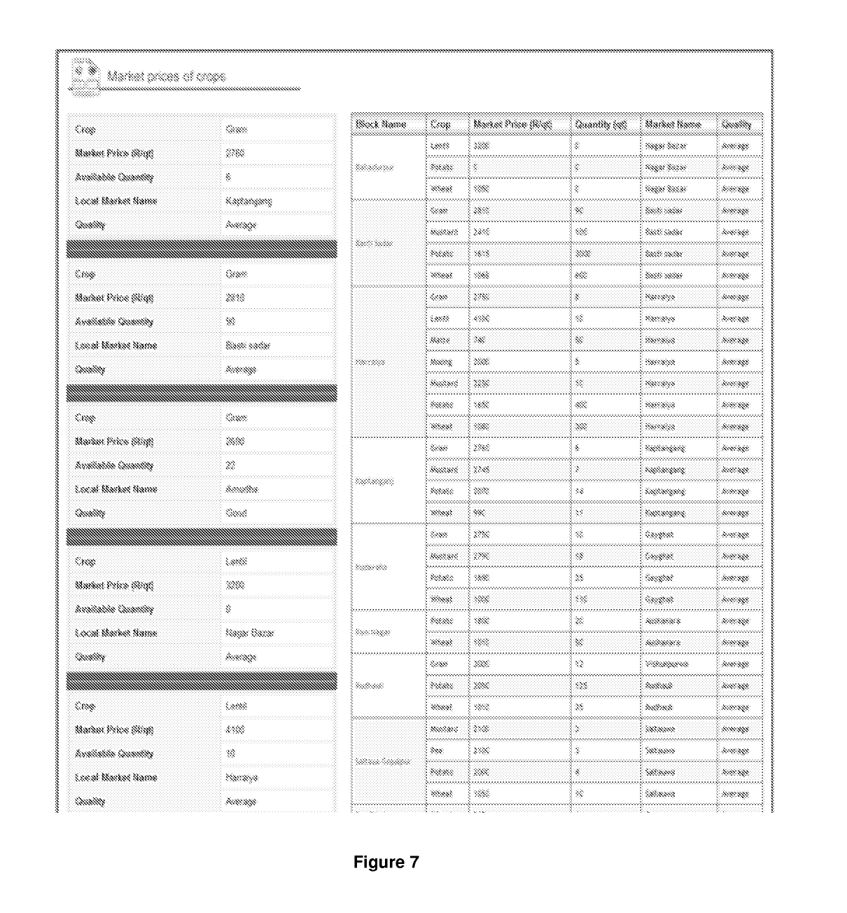

Referring to FIGS. 2 to 5 which illustrate a risk status of different districts, according to an exemplary embodiment of the present invention. Customized training programmes and technology for on-farm demonstrations are formulated based on the information collected on both bio-physical and socio-economic situations of the villages. Customized training programmes and on-farm demonstrations cover specific interventions like implication of soil fertility status, selection of quality planting material including its duration to fit into the farming system, seed replacement, nursery management, optimum amount and time of use of input, method of input application, water scheduling, control measure for pests and diseases based on its seasonal incidence including natural control, application of manures and fertilizers, seasonal weeds control, management of natural resources and farm resources within cropping season, post harvest handling, packaging, storage, use of market intelligence and marketing. The unique feature of the extension system of the present invention is its implementation by providing advisory services based on real time crop conditions which include weather forecasting, weather and crop advisory.

### EXAMPLE 2

### Operation Model of Farming System Analysis

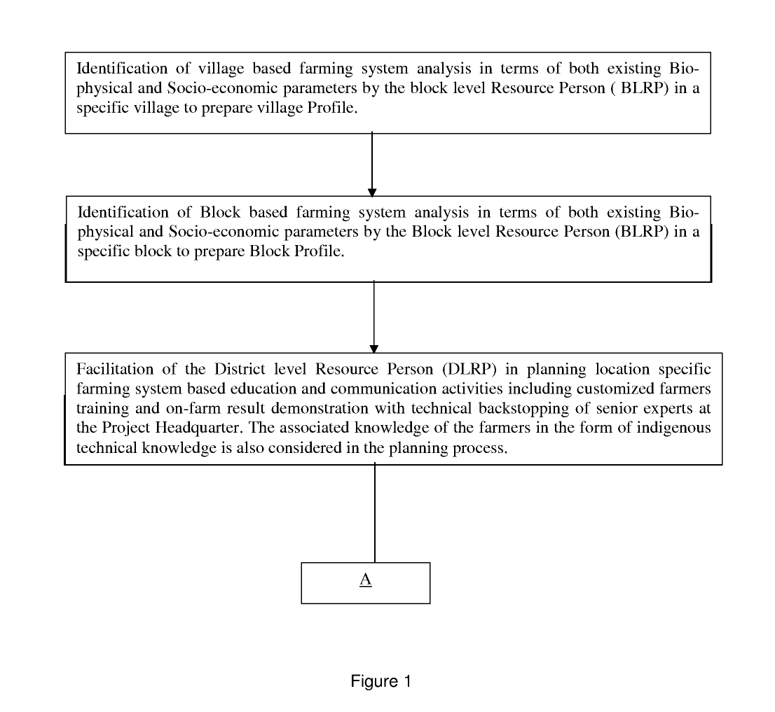

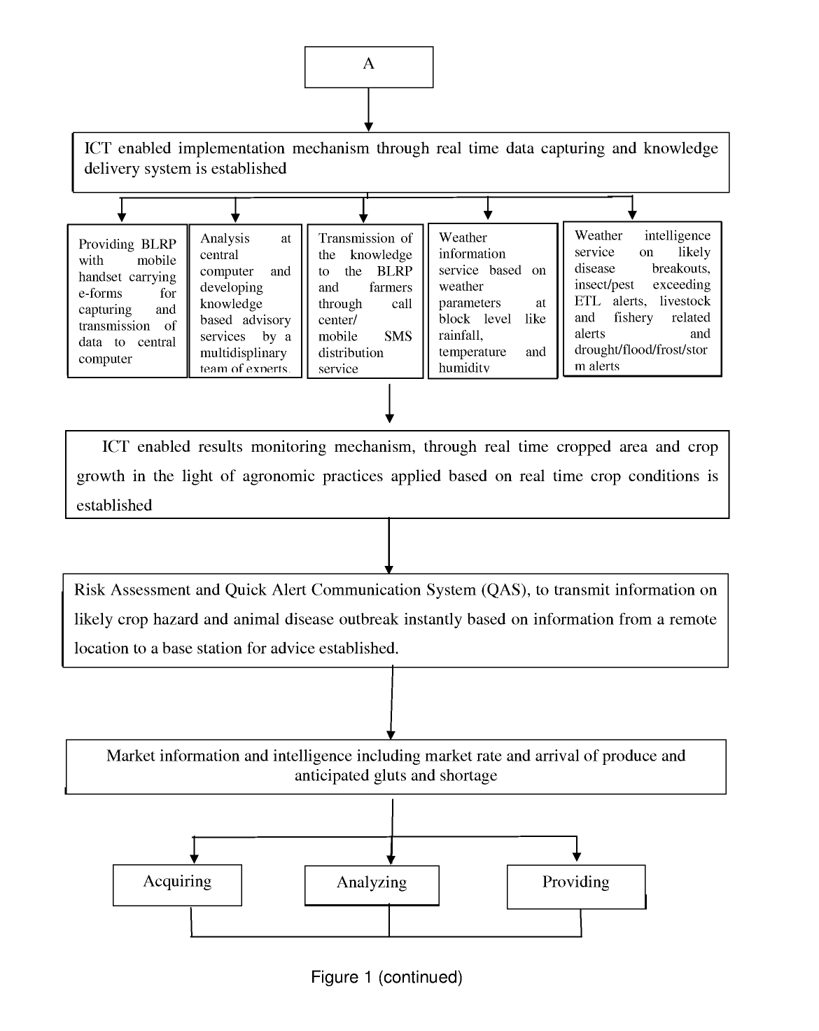

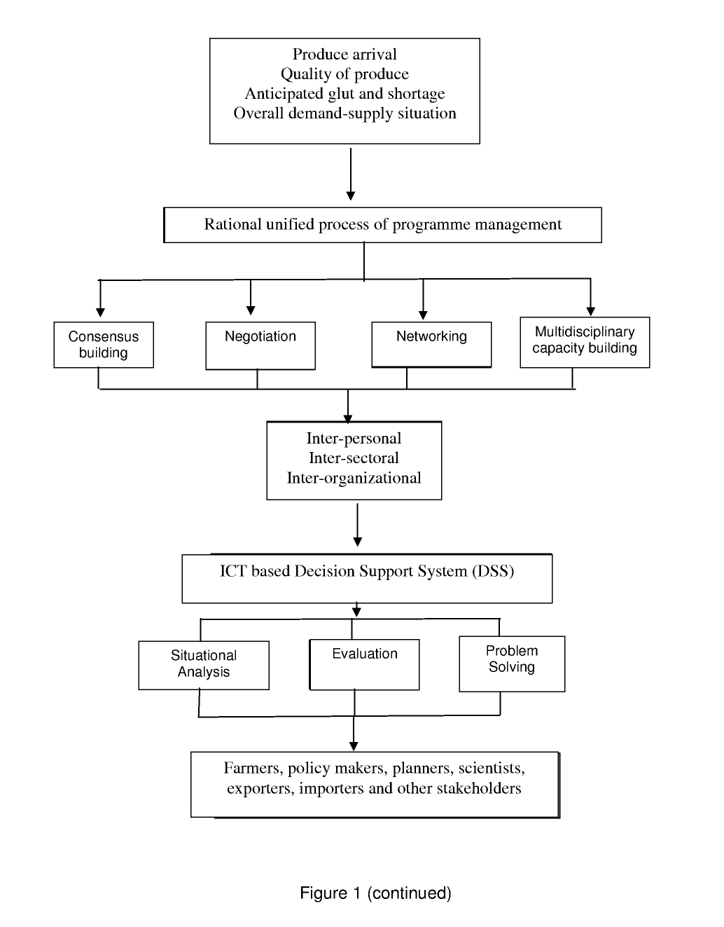

Referring to FIG. 1 which illustrates a flow chart of the information on existing bio-physical parameters, according to an exemplary embodiment of the present invention. The real time information may be collected by establishing meteorological station at block level to facilitate precise advisory services on real time basis including risk assessment and quick alert on likely effect of sudden changes of weather parameters on crops and immediate remedial measures. This information may be upgraded on weekly basis and available on line to facilitate appropriate strategies.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

1-8. (canceled)

9. A method of agriculture management comprising the steps of:
gathering field data via customized trained block level resource person in an e-form on all data of field and crop on real time basis, via a hand held device. data including location specific information, bio-physical information, socio economic information, soil, water resources, disease control measures and information alike thereof;
transmitting the gathered sampling data to a centralized information storing and processing unit/databases for risk assessment and quick alert communication system;
analyzing the gathered data from location specific area regarding respective situation via analytical software and expert multidisciplinary panel for generation of management analysis; the transmission of analysis via global transmission communication; and
communicating electronically for receiving the generated customized management analysis via server free wireless global communication in real time on a hand held device to the block level resource person.

10. The method of claim 9, wherein the training is customized and imparted by a district level resource person.

11. The method of claim 10, wherein the training includes location specific farming system based education, on site demonstration, communication activities and other services that facilitate the working and development of the block level resource person.

12. The method of claim 9, wherein the data is collected through e-form on wide range of field data, crop information and weather data on real time basis.

13. A method of ICT based acquiring, analyzing and providing market information at block level to facilitate decision making by the farmers comprising:
gathering market data for quality, arrival, anticipated glut, shortage and overall demand-supply situation of the produce on a hand held server free communication device via customized mobile e-form;
providing the data to a central information storing and processing unit;
providing the data to a decision support system comprising officials of line department, policy makers and planners with logistics and software; and
communicating the solution to policy makers, planners, scientists, exporters and other stake holders via hand held server free communication device.

14. A method of extension program management involving interpersonal, inter-sectoral and inter-organizational communications coupled with consensus-building, negotiation, networking and multidisciplinary capacity building in a multi-cultural settings as appropriate at different levels.
